(19) United States
(12) Patent Application Publication
(10) Pub. No.: US 2012/0177022 A1
(43) Pub. Date: Jul. 12, 2012

(54) WIRELESS LAN SYSTEM, COMMUNICATION DEVICE AND METHOD OF SHARING SETTING INFORMATION

(75) Inventor: Goki ICHIKAWA, Aichi (JP)

(73) Assignee: Buffalo Inc., Nagoya-shi (JP)

(21) Appl. No.: 13/346,834

(22) Filed: Jan. 10, 2012

(30) Foreign Application Priority Data
Jan. 11, 2011 (JP) 2011-2873

(51) Int. Cl. H04W 68/00; H04W 84/12

(52) U.S. Cl. 370/338

(57) ABSTRACT

A wireless local area network (LAN) system that includes first and second devices that performing a sharing operation of sharing setting information for establishing a wireless LAN connection. The first device includes a first notification module that notifies a ready status for the sharing operation between the first device and the second device prior to performing the sharing operation, and a first instruction receiving module that receives an instruction for performing the sharing operation in cooperation with the second device after the notifying by the first notification module. The second device includes a second notification module that notifies a ready status for the sharing operation between the first device and the second device prior to performing the sharing operation, and a second instruction receiving module that receives an instruction for performing the sharing operation in cooperation with the first device after the notifying by the second notification module.

### CROSS-REFERENCE TO RELATED APPLICATION

This application claims the priority based on Japanese Patent Application No. 2011-2873 filed on Jan. 11, 2011, the disclosure of which is hereby incorporated by reference in its entirety.

### BACKGROUND

1. Technical Field

This disclosure relates to a wireless Local Area Network (LAN) system, a communication device and a method of sharing setting information.

2. Related Art

Recently, wireless LANs have been used widely. In the wireless LAN, setting information with respect to settings for wireless communication is shared between communication devices making communication. For example, when the wireless LAN is compliant with the IEEE 802.11 standard, a least a SSID (Service Set Identifier) is shared between the communication devices. In encrypted communication, information, such as encryption method and encryption key, is shared between the communication devices.

For example, WPS (Wi-Fi-Protected Setup) and AOSS (AirStation One-Touch Secure System, trademark by Buffalo Inc.) are known technologies for easily sharing such setting information. These technologies enable the setting information to be shared between an access point and a station by wireless communication by the user's depression of a button or by the user's access to a WEB setting window via a WEB browser to give preset instructions to the access point and the station. This improves the user's convenience, compared with the user's manual input of the setting information.

When a next-door third person simultaneously activates WPS or AOSS for communication devices during the user activating WPS or AOSS for communication devices, however, there is a possibility that the user's station is connected to the third person's access point or that the third person's station is connected to the user's access point.

During the user activating WPS or AOSS for communication devices, the user has difficulty in identifying the devices that actually share the setting information or difficulty in checking whether the setting information is adequately shared between the user's expected devices.

Consequently, there is a need to improve the user's convenience in sharing setting information between communication devices.

### SUMMARY

According to a first exemplary embodiment, the disclosure is directed to a wireless local area network (LAN) system that includes first and second devices that performing a sharing operation of sharing setting information for establishing a wireless LAN connection. The first device includes a first notification module that notifies a ready status for the sharing operation between the first device and the second device prior to performing the sharing operation, and a first instruction receiving module that receives an instruction for performing the sharing operation in cooperation with the second device after the notifying by the first notification module. The second device includes a second notification module that notifies a ready status for the sharing operation between the first device and the second device prior to performing the sharing operation, and a second instruction receiving module that receives an instruction for performing the sharing operation in cooperation with the first device after the notifying by the second notification module.

According to another exemplary embodiment, the disclosure is directed to a communication device in a wireless local area network (LAN) that performs a sharing operation of sharing setting with another communication device to establish a connection with the another communication device. The communication device includes a notification module that notifies a ready status for the sharing operation between the communication device and the another communication device prior to performing the sharing operation, and an instruction receiving module that receives an instruction for performing the sharing operation in cooperation with the another communication device after the notifying by the notification module.

According to another exemplary embodiment, the disclosure is directed to a communication device in a wireless local area network (LAN) that performs a sharing operation of sharing setting information with another communication device to establish a connection with the another communication device. The communication device includes a notification module that notifies a ready status for the sharing operation between the communication device and the another communication device prior to performing the sharing operation, an instruction receiving module that receives an instruction for performing the sharing operation in cooperation with the another communication device after the notifying by the notification module, a specification module that specifies the another communication device as an object candidate of the sharing operation, a reserving operation module that performs a reserving operation to allow for the sharing operation between the communication device and the another communication device specified as the object candidate, and a sharing operation module that performs a sharing operation by sharing setting information with the second communication device. The notification module performs the notifying when the reserving operation is completed, the instruction receiving module receives an instruction for performing the sharing operation when the reserving operation is completed, and the sharing operation module performs the sharing operation when the instruction for performing the sharing operation is received by the instruction receiving module.

According to another exemplary embodiment, the disclosure is directed to a communication device in a wireless local area network (LAN) that performs a sharing operation of sharing setting information with another communication device to establish a connection with the another communication device. The communication device includes a notification module that notifies a ready status for the sharing operation between the another communication device and the communication device prior to performing the sharing operation, an instruction receiving module that receives an instruction for performing the sharing operation in cooperation with the another communication device after the notifying by the notification module, a specification module that specifies the another communication device as an object of the sharing operation, a reserving operation module that performs a reserving operation to allow for the sharing operation between the communication device and the specified another communication device, and a sharing operation module that performs a sharing operation by sharing setting information of the communication device with the another communication device. The notification module performs the notifying when the reserving operation is completed, the instruction receiving module receives an instruction for performing the sharing operation when the reserving operation is completed, and the sharing operation module performs the sharing operation when the instruction for performing the sharing operation is received by the instruction receiving module.

According to another exemplary embodiment, the disclosure is directed to a method of performing a sharing operation of sharing setting information for establishing a wireless LAN connection between a first communication device and a second communication device. The method includes first notifying, by the first communication device, a ready status for the sharing operation between the first communication device and the second communication device prior to performing the sharing operation, second notifying, by the second communication device, a ready status for the sharing operation between the first communication device and the second communication device prior to performing the sharing operation, first receiving, at the first communication device, an instruction for performing the sharing operation in cooperation with the second communication device after the first notifying, and second receiving, at the second communication device, an instruction for performing the sharing operation in cooperation with the first communication device after the second notifying.

### BRIEF DESCRIPTION OF THE DRAWINGS

FIG. 1 illustrates the general configuration of a wireless LAN system according to one embodiment of the disclosure;

FIG. 2 illustrates the general structure of a wireless station STA;

FIG. 3 illustrates the general structure of an access point AP1;

FIG. 4 illustrates one exemplary environment surrounding the access point AP1 expected in the state that automatic setting process is performed;

FIG. 5 is a flowchart showing the general flow of automatic setting process;

FIG. 6 illustrates the detailed process flow of object candidate specifying phase;

FIG. 7 illustrates the detailed process flow of reservation phase;

FIG. 8 illustrates the detailed process flow of sharing operation phase;

FIG. 9 illustrates the detailed process flow of reservation cancelling phase; and

FIG. 10 illustrates the detailed process flow of reservation cancelling phase when a function button 60 of the wireless station STA is depressed.

### DETAILED DESCRIPTION

Embodiments of the disclosure are described below with reference to the accompanied drawings in the following sequence:

### A. Embodiment

A1. General Configuration of Wireless LAN System

A2. Process for Sharing Setting Information

A3. Effects of Embodiment

### B. Modifications

### A. Embodiment

A1. General Configuration of Wireless LAN System

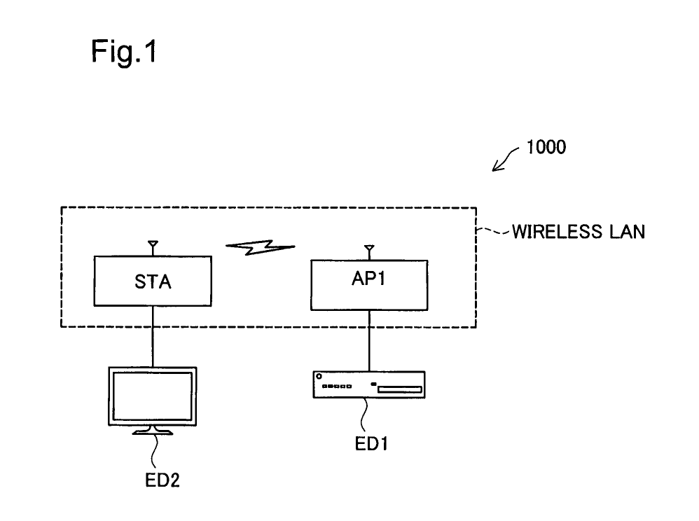

FIG. 1 illustrates the general configuration of a wireless LAN system 1000 according to one embodiment. The wireless LAN system 1000 includes an access point AP and a wireless station STA, and communication is made between the access point AP and the wireless station STA by wireless LAN. The access point AP1 has access point function for relaying communication between wireless stations STA and bridging function for interconnecting a wired LAN with a wireless LAN. The wireless station STA is a so-called Ethernet (registered trademark) converter having station function and bridging function for interconnecting a wired LAN with a wireless LAN. The wireless station STA is an example of the “first communication device” of the claims, and the access point AP1 is an example of the “second communication device” of the claims.

The access point AP1 has a wired LAN port, to which an electronic device ED1 having a wired LAN port is connected via a wired LAN cable. The electronic device ED1 is a network-ready Blu-ray (registered trademark) player in this embodiment. The wireless station STA has a wired LAN port, to which an electronic device ED2 having a wired LAN port is connected via a wired LAN cable. The electronic device ED2 is a network-ready TV set in this embodiment.

In the wireless LAN system 1000, the access point AP1 and the wireless station STA make wireless communication in infrastructure mode to allow for communication between the electronic device ED1 and the electronic device ED2. For example, video data and audio data reproduced by the Blu-ray player are transferred via wireless LAN to the network-ready TV set, so that the user can watch the video image along with sound on the network-ready TV set away from the Blu-ray player.

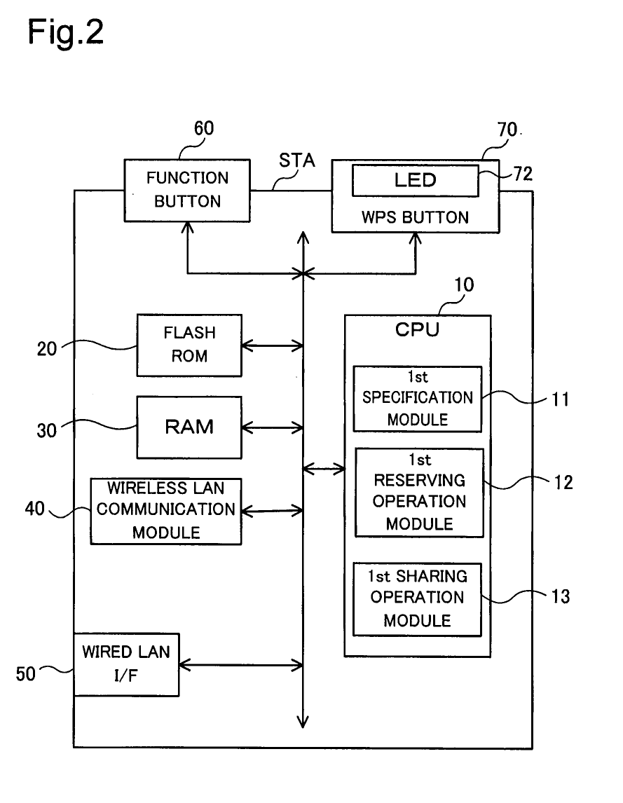

FIG. 2 illustrates the general structure of the wireless station STA. The wireless station STA includes a CPU 10, a flash ROM 20, a RAM 30, a first wireless LAN communication module 40, a wired LAN interface 50, a function button 60 and a WPS button 70.

The CPU 10 loads and executes a program, such as firmware, which is stored in the flash ROM 20, on the RAM 30 to control the general operations of the wireless station STA. The CPU 10 also executes a predetermined program to serve as a first specification module 11, a first reserving operation module 12 and a first sharing operation module 13. The details of these functional modules will be described later.

The first wireless LAN communication module 40 is a circuit for making wireless communication conforming to the wireless LAN standard. This first wireless LAN communication module 40 includes hardware such as a modulator, an amplifier and an antenna to send and receive radio signals to and from outside. The first wireless LAN communication module 40 includes a circuit measuring Received Signal Strength Indication (hereinafter called RSSI value) representing the strength of received radio signal. In this embodiment, the first wireless LAN communication module 40 is configured to serve as a station conforming to the IEEE 802.11 standard. The first wireless LAN communication module 40 may be controlled by the CPU 10 to virtually serve as two logical devices, i.e., station and access point, simultaneously or to selectively and exclusively serve as one of the logical devices, i.e., access point or station, at any arbitrary time.

The wired LAN interface 50 is used to connect the wireless station STA to the wired LAN. In this embodiment, the wired LAN interface 50 is configured to conform to the IEEE 802.3 standard. This wired LAN interface 50 includes a wired LAN port, to which the electronic device ED2 is connected.

The function button 60 is used to activate various operations on the wireless station STA. In this embodiment, the user's depression of the function button 60 starts automatic setting process described later. The function button 60 is an example of the “third instruction receiving module” of the claims.

The WPS button 70 is used in the automatic setting process described later. In this embodiment, during the automatic setting process, the user's depression of the WPS button 70 starts a first sharing operation described later. The WPS button 70 is made of translucent plastic and has an LED 72 provided inside thereof. Accordingly, the light emitted from the LED 72 is visible from outside of the WPS button 70. This LED 72 indicates the operating status of the wireless station STA during the automatic setting process. In this embodiment, the LED 72 is turned on when reserving operation described later is completed during the automatic setting process. The WPS button 70 is an example of the “first instruction receiving module” of the claims, and the LED 72 is an example of the “first notification module” of the claims.

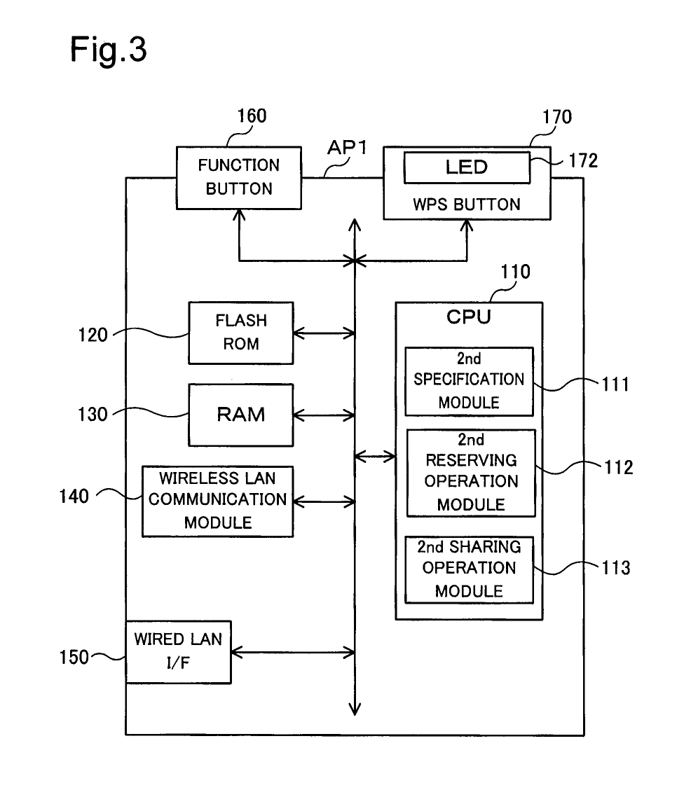

FIG. 3 illustrates the general structure of the access point AP1. The access point AP1 includes a CPU 110, a flash ROM 120, a RAM 130, a second wireless LAN communication module 140, a wired LAN interface 150, a function button 160 and a WPS button 170.

The CPU 110 loads and executes a program, such as firmware, which is stored in the flash ROM 120, on the RAM 130 to control the general operations of the access point AP1. The CPU 110 also executes a predetermined program to serve as a second specification module 111, a second reserving operation module 112 and a second sharing operation module 113. The details of these functional modules will be described later.

The second wireless LAN communication module 140 is a circuit for making wireless communication conforming to the wireless LAN standard. This second wireless LAN communication module 140 includes hardware such as a modulator, an amplifier and an antenna to send and receive radio signals to and from outside. In this embodiment, the second wireless LAN communication module 140 is configured to serve as an access point conforming to the IEEE 802.11 standard. The second wireless LAN communication module 140 may be controlled by the CPU 110 to virtually serve as two logical devices, i.e., access point and station, simultaneously or to selectively and exclusively serve as one of the logical devices, i.e., access point or station, at any arbitrary time.

The wired LAN interface 150 is used to connect the access point AP1 to the wired LAN. In this embodiment, the wired LAN interface 150 is configured to conform to the IEEE 802.3 standard. This wired LAN interface 150 includes a wired LAN port, to which the electronic device ED1 is connected.

The function button 160 is used to activate various operations on the access point AP1. This function button 160 may be omitted.

The WPS button 170 is used in the automatic setting process described later. In this embodiment, during the automatic setting process, the user's depression of the WPS button 170 starts a second sharing operation described later. The WPS button 170 is made of translucent plastic and has an LED 172 provided inside thereof. Accordingly, the light emitted from the LED 172 is visible from outside of the WPS button 170. This LED 172 indicates the operating status of the access point AP1 during the automatic setting process.

In this embodiment, the LED 172 is turned on when reserving operation described later is completed during the automatic setting process. The WPS button 170 is an example of the “second instruction receiving module” of the claims, and the LED 172 is an example of the “second notification module” of the claims.

A2. Process for Sharing Setting Information

The automatic setting process performed between the wireless station STA and the access point AP1 is described. The automatic setting process of this embodiment is WPS-compliant process and includes a series of operations to share setting information including information required for establishing the wireless LAN system 1000 between the wireless station STA and the access point AP1. In this embodiment, the setting information includes ESSID (Extended Service Set Identifier), authentication method, encryption method and encryption key (or information for generating the encryption key).

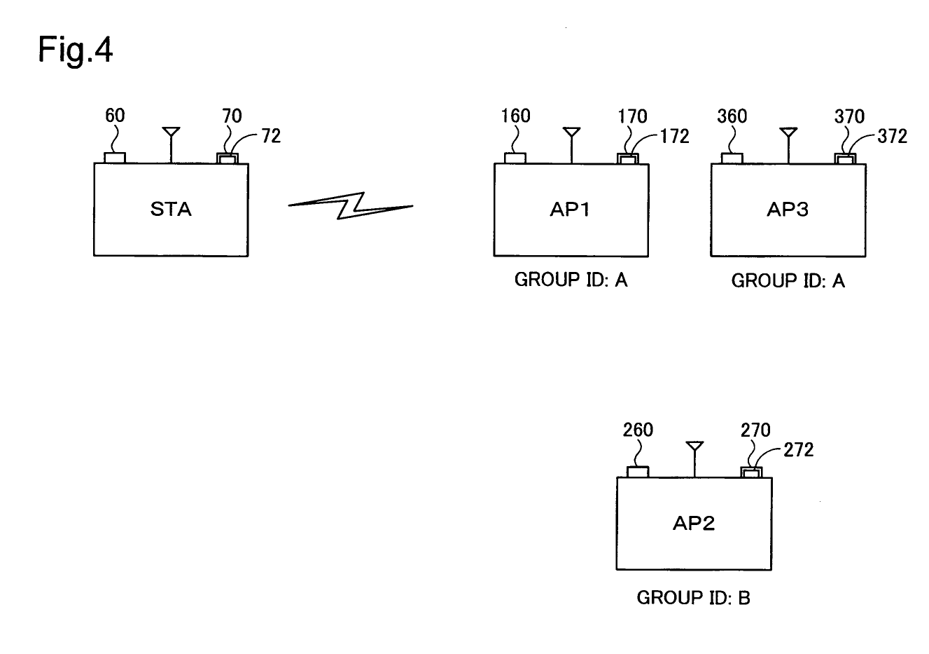

FIG. 4 illustrates one exemplary environment surrounding the access point AP1 expected in the state that the automatic setting process is performed. Other access points AP2 and AP3 having the similar structure to that of the access point AP1 are provided around the access point AP1. Like the access point AP1, the access point AP2 includes a function button 260 and a WPS button 270 containing an LED 272. Similarly, the access point AP3 includes a function button 360 and a WPS button 370 containing an LED 372. Other wireless stations are also provided around the access point AP1 to establish a wireless LAN including, for example, the access point AP1 or the access point AP2 in the actual state, but are omitted for convenience of description.

In this embodiment, the access point AP1 has group ID “A”. The access point AP2 has group ID “B”. The access point AP3 has group ID “A”. The “group ID” is a unique value, each being allocated to one set of setting information (combination of for example, ESSID, authentication method, encryption method and encryption key). Accordingly, different access points having one identical group ID means that these access points have an identical set of setting information. In this embodiment, the access points AP1 and AP3 have identical group ID “A” and accordingly have an identical set of setting information.

The group ID is updated at each access point every time the setting information is changed. This embodiment uses a GUID (Globally Unique Identifier), which is pseudorandom number generated by software, for the group ID. The actual group ID (GUID) is a 128-bit value, but is conveniently expressed as the group ID “A” in the description hereof for convenience sake. The following describes the automatic setting process performed by the user between the wireless station STA and the access point AP1.

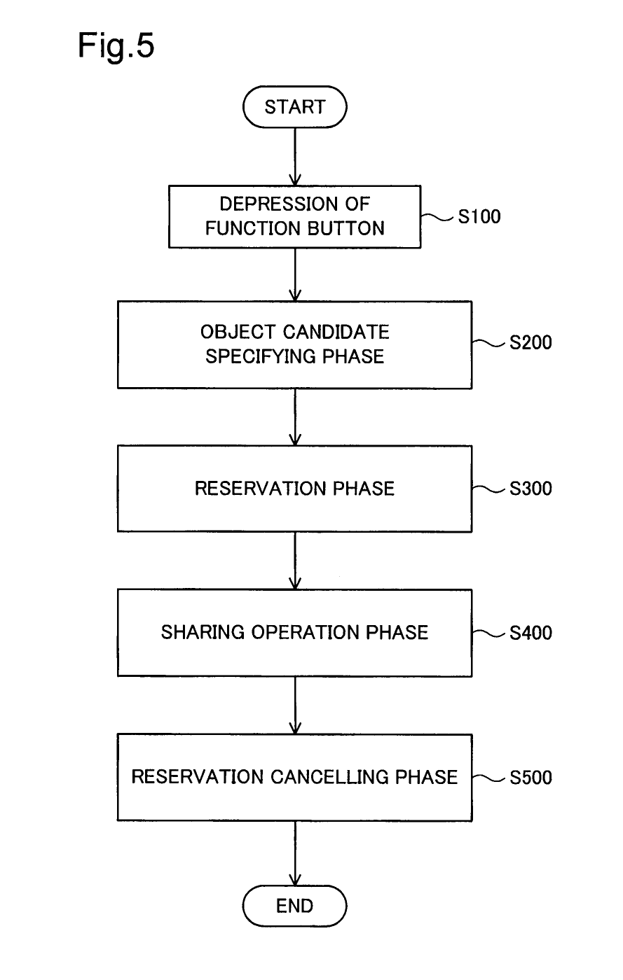

FIG. 5 is a flowchart showing the general flow of the automatic setting process. The details of the automatic setting process will be described later. When the user depresses the function button 60 of the wireless station STA (step S100), object candidate specifying phase starts.

In the object candidate specifying phase (step S200), the first specification module 11 of the wireless station STA specifies the access point AP1 as an object candidate of sharing operation, based on the RSSI value measured by the first wireless LAN communication module 40. The first specification module 11 of the wireless station STA also specifies the access point AP3 having the identical group ID with that of the access point AP1 as an object candidate of sharing operation. The sharing operation is process of sharing (exchanging) the setting information between a wireless station and an access point.

The second specification module 111 of the access point AP1 specifies the wireless station STA as the object of sharing operation. Similarly, the second specification module (not shown) of the access point AP3 specifies the wireless station STA as the object of sharing operation. On completion of this object candidate specifying phase, the process proceeds to reservation phase.

In the reservation phase (step S300), the first reserving operation module 12 of the wireless station STA performs reserving operation to the specified object candidates of sharing operation (i.e., access point AP1 and access point AP3). The reserving operation performed by the first reserving operation module 12 is process of restricting the sharing operation between the wireless station STA and any device other than the specified object candidate of sharing operation, while enabling the sharing operation only between the wireless station STA and the specified object candidate of sharing operation. On completion of the reserving operation, the wireless station STA turns on the LED 72. In the description below, the wireless station STA “cancelling reservation” means that the first reserving operation module 12 of the wireless station STA cancels the process of restricting the sharing operation between the wireless station STA and any device other than the specified object candidate of sharing operation, while enabling the sharing operation only between the wireless station STA and the specified object candidate of sharing operation.

The second reserving operation module 112 of the access point AP1 performs reserving operation to the specified object of sharing operation (wireless station STA). The reserving operation performed by the second reserving operation module 112 is process of restricting the sharing operation between the access point AP1 and any device other than the specified object of sharing operation, while enabling the sharing operation only between the access point AP1 and the specified object of sharing operation. Similarly, the second reserving operation module (not shown) of the access point AP3 performs reserving operation to the specified object of sharing operation (wireless station STA). On completion of the reserving operation, the LED 172 of the access point AP1 and the LED 372 of the access point AP3 are turned on. On completion of the reservation phase, the process proceeds to sharing operation phase. In the description below, the access point AP1 “cancelling reservation” means that the second reserving operation module 112 of the access point AP1 cancels the process of restricting the sharing operation between the access point AP1 and any device other than the specified object of sharing operation, while enabling the sharing operation only between the access point AP1 and the specified object of sharing operation.

In the sharing operation phase (step S400), in response to the user's depression of the WPS button 70 of the wireless station STA and the WPS button 170 of the access point AP1, the first sharing operation module 13 of the wireless station STA performs first sharing operation, which is a process by one entity of sharing operation, whilst the second sharing operation module 113 of the access point AP1 performs second sharing operation, which is a process by the other entity of sharing operation. More specifically, the sharing operation is performed between the wireless station STA and the access point AP1 to share the setting information. When the sharing operation is completed, the first reserving operation module 12 of the wireless station STA and the second reserving operation module 112 of the access point AP1 respectively cancel the own reservations. On completion of the sharing operation phase, the process proceeds to reservation cancelling phase.

In the reservation cancelling phase (step S500), the wireless station STA broadcasts a reservation cancelling request. The access point AP3 receives the reservation cancelling request and cancels the own reservation. The following describes the detailed processing flow of each phase.

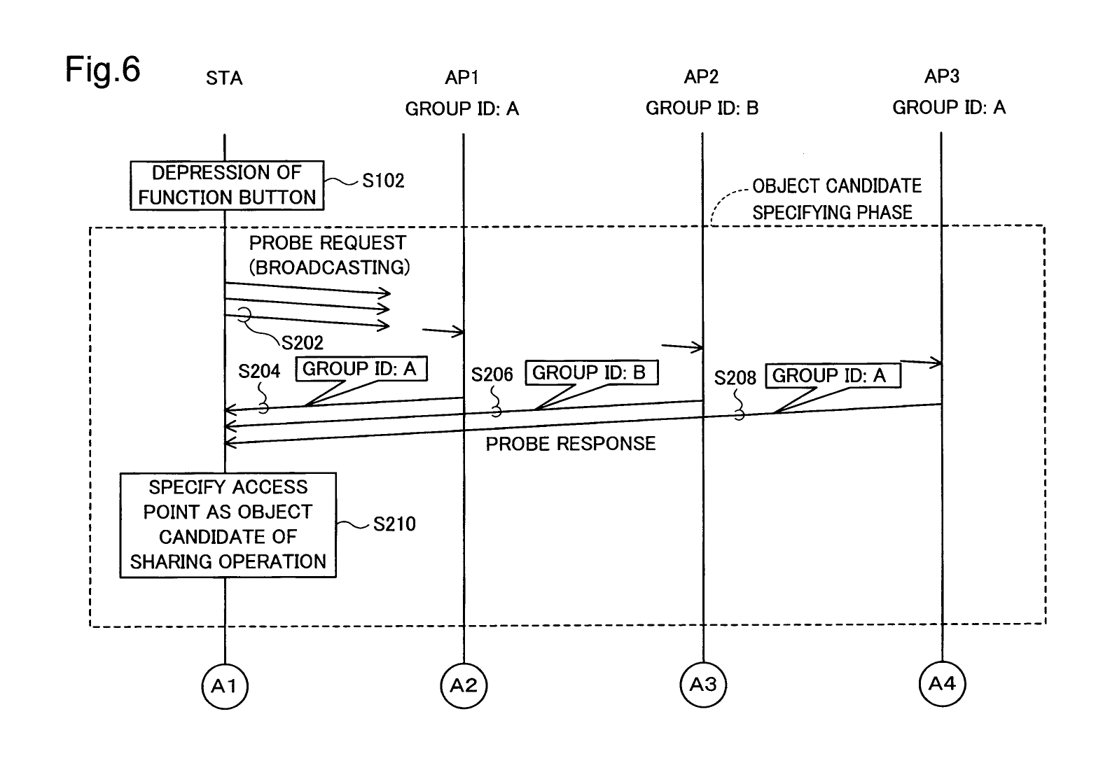

FIG. 6 illustrates the detailed process flow of the object candidate specifying phase. When the user depresses the function button 60 of the wireless station STA (step S102), the wireless station STA broadcasts a probe request (step S202). The probe request is signal used to search for any surrounding access points Each of the access points that has received the probe request sends back a probe response including the “own group ID” in its vendor-specific information element to the wireless station STA. The probe response is signal responding to the probe request.

In this embodiment, the access point AP1 sends back a probe response including “group ID: A” in its vendor-specific information element (step S204). The access point AP2 sends back a probe response including “group ID: B” in its vendor-specific information element (step S206). The access point AP3 sends back a probe response including “group ID: A” in its vendor-specific information element (step S208).

The wireless station STA receives the probe response from each of the access points and measures the RSSI value of the received probe response by the first wireless LAN communication module 40. The wireless station STA then specifies an access point as an object candidate of sharing operation, based on the measured RSSI values (step S210). More specifically, the wireless station STA specifies an access point having the RSSI value that is not less than a reference level and is the highest, as an object candidate of sharing operation. Since the closer distance between devices tends to give the higher RSSI value, specifying the access point having the RSSI value that is not less than the reference level and is the highest as the object candidate of sharing operation means specifying the access point closest to the wireless station STA as the object candidate of sharing operation.

In the description of the embodiment, it is assumed that the RSSI value of the probe response sent from the access point AP1 is not less than the reference level and is the highest. In this embodiment, the wireless station STA accordingly specifies the access point AP1 as an object candidate of sharing operation.

In this embodiment, the wireless station STA also specifies the access point AP3 having the identical group ID “A” with that of the access point AP1 as an object candidate of sharing operation. In other words, the wireless station STA specifies the access points having the group ID “A” as object candidates of sharing operation.

When reserving operation has been completed between an access point and another wireless station, the access point sends back a probe response including “reserved” status, “own group ID” and “MAC address of wireless station with reservation accepted” in its vendor-specific information element to the wireless station STA.

As described above, when the vendor-specific information element of the probe response sent from the access point includes information indicating completion of reserving operation to another wireless station, the object candidate specifying phase terminates with error at the wireless station STA. More specifically, when the vendor-specific information element of the probe response sent from the access point AP1 includes “reserved” status, “group ID: A” and “MAC address of another wireless station having reservation”, the object candidate specifying phase terminates with error at the wireless station STA.

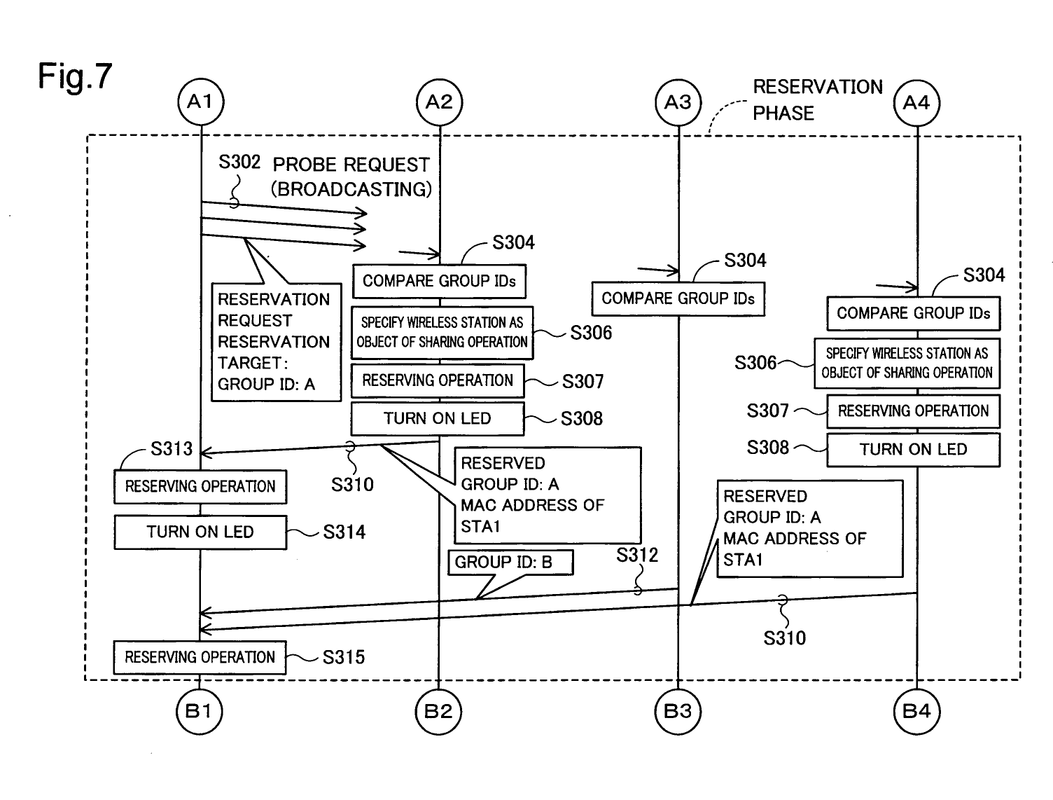

The encircled symbols, such as “A1”, in FIG. 6 show continuation of the process to the corresponding symbols in FIG. 7. The same is true for FIG. 7 and subsequent drawings.

FIG. 7 illustrates the detailed process flow of the reservation phase. The wireless station STA broadcasts a probe request including “reservation request” and “reservation target group ID: A” in its vendor-specific information element (step S302). Each access point that has received the probe request compares the own group ID with the reservation target group ID included in the vendor-specific information element (step S304).

When the two group IDs are identical with each other, each access point having the matching ID specifies the wireless station, which is the sender of the probe request, as the object of sharing operation (step S306) and performs reserving operation to the specified wireless station (step S307). On completion of the reserving operation, the access point turns on the own LED (step S308). After turning on the LED, the access point sends back a probe response including “reserved” status, “own group ID” and “MAC address of wireless station with reservation accepted” in its vendor-specific information element to the wireless station, which is the sender of the probe request (i.e., wireless station specified as the object of sharing operation) (step S310).

When the two group IDs are different from each other, on the other hand, each access point having the mismatching ID sends back a probe response including “own group ID” in its vendor-specific information element to the wireless station, which is the sender of the probe request (step S312).

In this embodiment, both the access point AP1 and the access point AP3 having the matching group ID specify the wireless station STA as the object of sharing operation (step S306) and perform reserving operation to the specified wireless station STA (step S307). In this embodiment, the reserving operation by the access point AP1 and the access point AP3 restricts the sharing operation with any device other than the wireless station having the MAC address included in the probe request including reservation request, while enabling the sharing operation only to the wireless station having the MAC address included in the probe request including reservation request. According to this embodiment, the access point tentatively creates a list of MAC addresses as the object of restricting the sharing operation and a list of MAC addresses as the object of enabling the sharing operation and performs the reserving operation according to these lists. The access point may cancel the reservation by destroying these lists.

On completion of reserving operation, the access point AP1 and the access point AP3 respectively turn on the own LEDs 172 and 372 (step S308). After turning on the LED 172 or 372, each of the access point AP1 and the access point AP3 sends back a probe response including “reserved” status, “group ID: A” and “MAC address of the wireless station STA with reservation accepted” in its vendor-specific information element to the wireless station STA (step S310).

The access point AP2 having the mismatching group ID, on the other hand, does not accept a reservation request from the wireless station STA. The access point AP2 accordingly does not perform the reserving operation to the wireless station STA but sends back a probe response including the own group ID (group ID: B) in its vendor-specific information element to the wireless station STA (step S312).

The wireless station STA that has received the probe response from the access point AP1 performs the reserving operation to the access point AP1 (step S313). In this embodiment, the reserving operation by the wireless station STA restricts the sharing operation with any device other than the access point having the MAC address included in the probe response including “reserved” status, while enabling the sharing operation to only the access point having the MAC address included in the probe response including “reserved” status. According to this embodiment, the wireless station STA tentatively creates a list of MAC addresses as the object of restricting the sharing operation and a list of MAC addresses as the object of enabling the sharing operation during the reserving operation. The wireless station STA may cancel the reservation by destroying these lists. On completion of the reserving operation, the wireless station STA turns on the own LED 72 (step S314).

In this embodiment, the wireless station STA also receives a probe response from the access point AP3 and performs the reserving operation to the access point AP3 (step S315). In other words, the wireless station STA performs the reserving operation to all the available access points having the group ID=“A”.

When the wireless station STA has not yet received any probe response including “reserved” status from any access point within a preset time period (for example, 120 seconds), the reservation phase terminates with error at the wireless station STA.

In the reservation phase, the wireless station STA accepts depression of the function button 60. During the reservation phase, when the user depresses the function button 60, the wireless station STA broadcasts a probe request including reservation cancelling request in its vendor-specific information element. The series of processing triggered by depression of the function button 60 of the wireless station STA will be described later.

When information indicating completion of the reserving operation to another wireless station is included in the vendor-specific information element of the probe response sent from the access point, the wireless station STA broadcasts a probe request including reservation cancelling request in its vendor-specific information element. The reservation phase then terminates with error at the wireless station STA.

When the reserving operation to the wireless station STA has already been completed before the access point AP2 receives the probe request from the wireless station STA (step S302), in other words, when the access point AP2 has failed to cancel the reservation to the wireless station STA, the access point AP2 cancels the reservation at this stage.

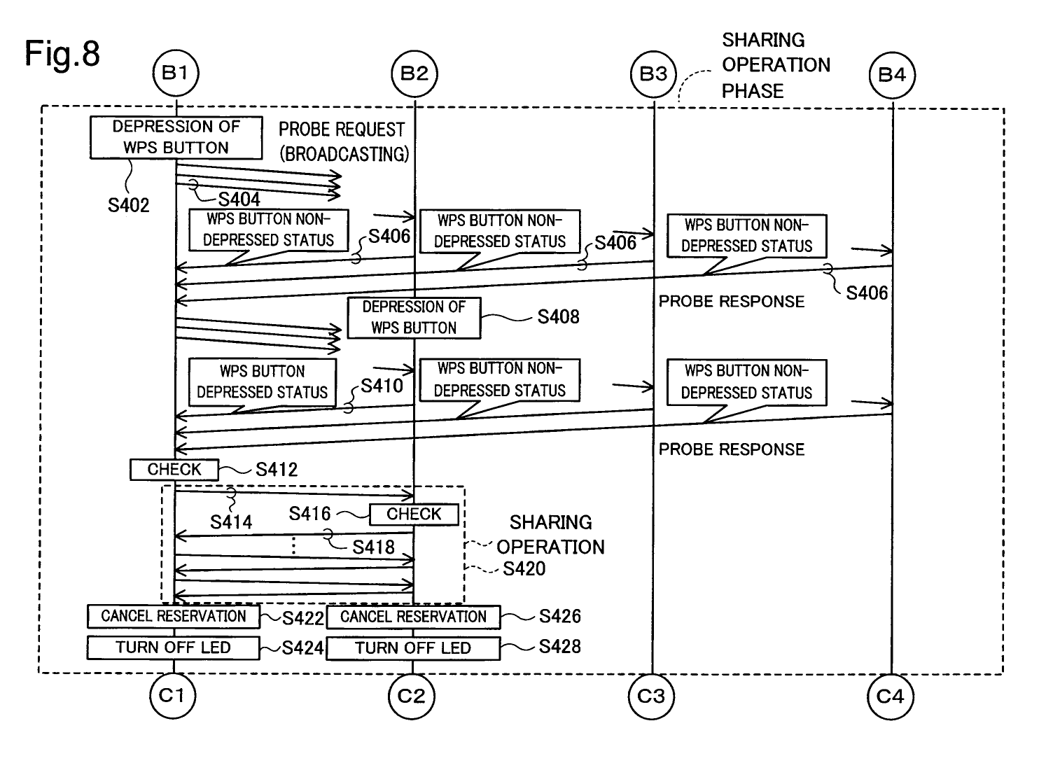

FIG. 8 illustrates the detailed process flow of the sharing operation phase. In this embodiment, on completion of the reservation phase, the LED 72 of the wireless station STA, the LED 172 of the access point AP1 and the LED 372 of the access point AP3 are all on. In this state, when the user depresses the WPS button 70 of the wireless station STA (step S402), the wireless station STA broadcasts a probe request (step S404). The wireless station STA broadcasts the probe request at step S404, in order to specify the access point having the depressed WPS button as described below.

The access point that has received the probe request from the wireless station STA sends back a probe response including information indicating whether the own WPS button is depressed in its vendor-specific information element to the wireless station STA. In the illustrated example of FIG. 8, at the time of the first probe response, the WPS button has not yet been depressed in any of the access points. Each of the access points AP1, AP2 and AP3 accordingly sends back a probe response including information indicating “WPS button non-depressed” status in its vendor-specific information element to the wireless station STA (step S406).

When the user subsequently depresses the WPS button of an access point (step S408), the access point sends back a probe response including information indicating “WPS button depressed” status in its vendor-specific information element to the wireless station STA (step S410). In the description of this embodiment, it is assumed that the WPS button 170 of the access point AP1 is depressed.

The wireless station STA that has received the probe responses from the respective access points AP1, AP2 and AP3 checks whether each of the received probe responses has been sent from the reserved access point by referring to the list of MAC addresses created during the reserving operation described above (step S313 of FIG. 7) and checks whether the WPS button is depressed, based on the information included in the vendor-specific information element of the probe response (step S412). In other words, the wireless station STA checks whether the WPS button is depressed with regard to only the probe response sent from the reserved access point as the target of detection. In this embodiment, the wireless station STA checks whether the WPS button is depressed with regard to only the probe responses sent from the access point AP1 and the access point AP3 having the group ID=“A” as the targets of detection.

When receiving a probe response including information indicating depression of the WPS button from the reserved access point, the wireless station STA starts first sharing operation to the access point (step S414). In this embodiment, since a probe response including information indicating “WPS button depressed” status in its vendor-specific information element is sent back from the access point AP1, the wireless station STA starts first sharing operation to the access point AP1. More specifically, the wireless station STA makes a connection request to the access point AP1 and starts the first sharing operation.

At step S416, the access point AP1 then checks whether the wireless station STA has been reserved as the object of sharing operation by referring to the list of MAC addresses created during the reserving operation described above (step S307 of FIG. 7). When the wireless station STA has been reserved as the object of sharing operation, the access point AP1 starts second sharing operation to the wireless station STA (step S418). More specifically, the access point AP1 accepts the connection request from the wireless station STA and starts the second sharing operation.

In this manner, the sharing operation is performed between the wireless station STA and the access point AP1 (step S420). This sharing operation is compliant with the WPS key exchange protocol and enables exchange of the setting information between the wireless station STA and the access point AP1. On completion of the sharing operation, the wireless station STA releases the connection with the access point AP1 for the sharing operation, cancels the own reservation (step S422) and turns off the own LED 72 (step S424). Simultaneously, the access point AP1 releases the connection with the wireless station STA for the sharing operation, cancels the own reservation (step S426) and turns off the own LED 172 (step S428).

When the user has not depressed the WPS button 70 of the wireless station STA within a preset time period (for example, 120 seconds) since lighting of the LED 72, the wireless station STA cancels the own reservation, broadcasts a probe request including reservation cancelling request (described below) in its vendor-specific information element, and turns off the own LED 72.

When the user has not depressed the WPS button 170 of the access point AP1 within a preset time period (for example, 120 seconds) since lighting of the LED 172, the access point AP1 cancels the own reservation and turns off the own LED 172. The access point AP3 performs the same series of processing.

Like the reservation phase, in the sharing operation phase, the wireless station STA also accepts depression of the function button 60. During the sharing operation phase, when the user depresses the function button 60, the wireless station STA cancels the own reservation and broadcasts a probe request including reservation cancelling request in its vendor-specific information element. The series of processing triggered by depression of the function button 60 of the wireless station STA will be described later.

According to one embodiment, when the user depresses the WPS button 370 of the access point AP3 after depression of the WPS button 170 of the access point AP1, the wireless station STA may enable the sharing operation only between the wireless station STA and the access point AP1, while restricting the sharing operation between the wireless station STA and the access point AP3. In other words, the wireless station STA may place restrictions to enable the first sharing operation only to the access point having the WPS button depressed first.

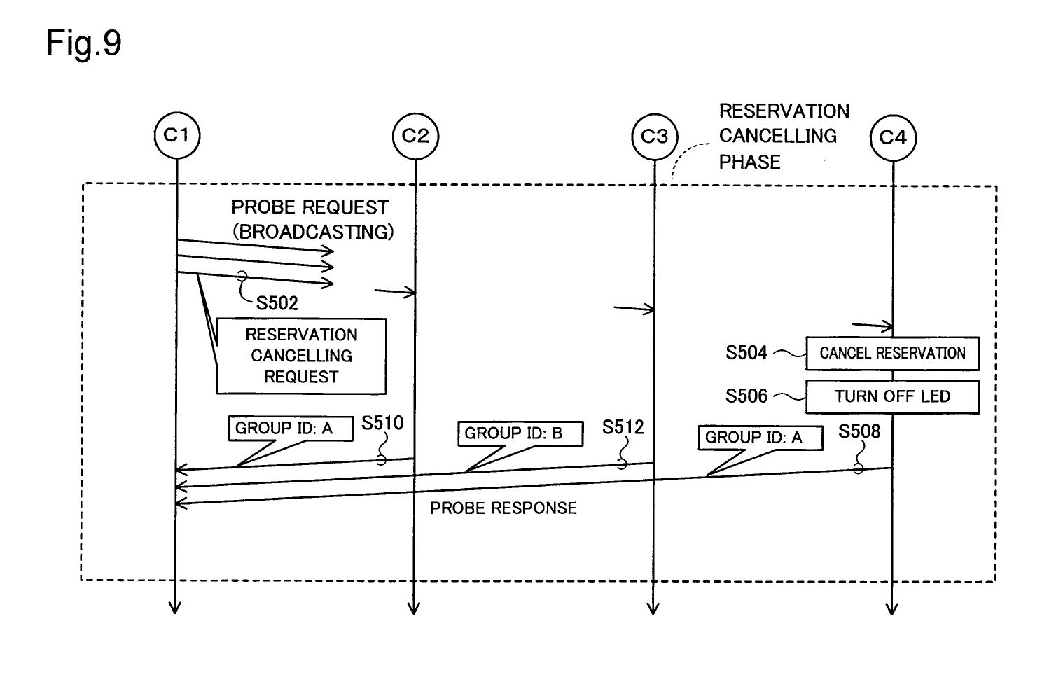

FIG. 9 illustrates the detailed process flow of the reservation cancelling phase. On completion of the sharing operation, the wireless station STA broadcasts a probe request including reservation cancelling request in its vendor-specific information element (step S502). The access point AP3 that has received the probe request including reservation cancelling request cancels the own reservation (step S504). After cancelling the own reservation, the access point AP3 turns off the LED 372 (step S506) and sends back a probe response including the own group ID (group ID: A) in its vendor-specific information element to the wireless station STA (step S508).

When receiving the probe request including reservation cancelling request, the access point AP1 that has already cancelled the own reservation on completion of the sharing operation sends back a probe response including the own group ID (group ID: A) in its vendor-specific information element to the wireless station STA (step S510). When receiving the probe request including reservation cancelling request, the access point AP2 that has not yet accepted reservation sends back a probe response including the own group ID (group ID: B) in its vendors-specific information element to the wireless station STA (step S512). This terminates the automatic setting process for sharing the setting information.

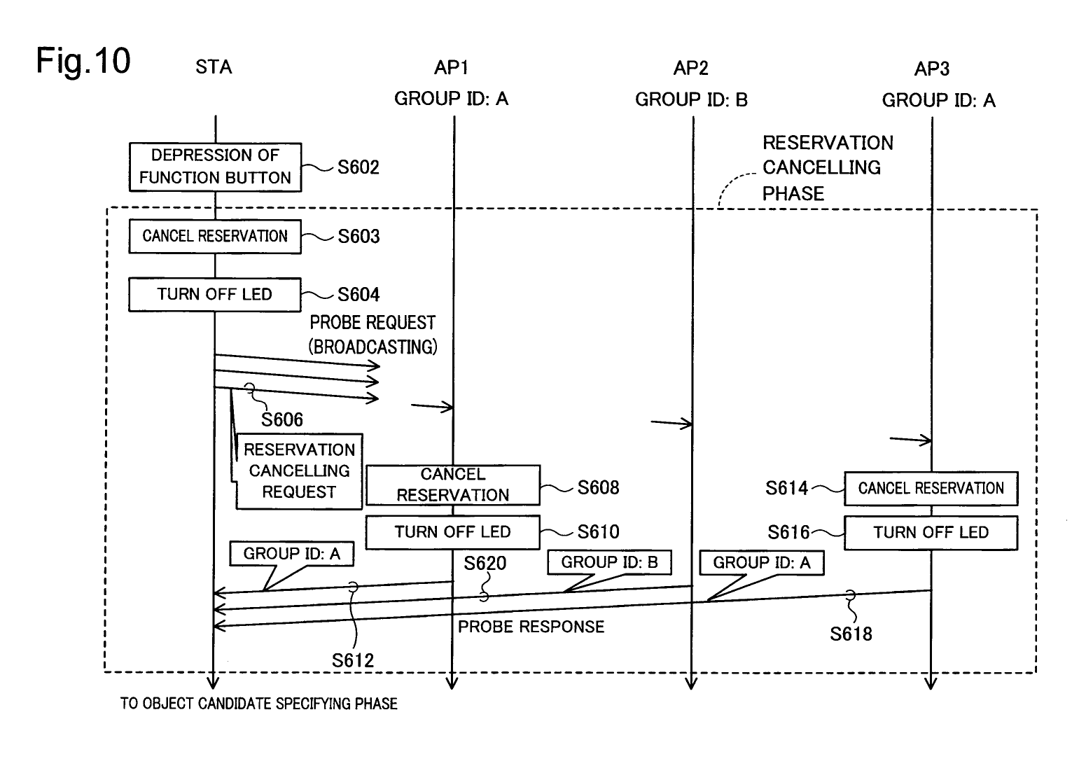

FIG. 10 illustrates the detailed process flow of the reservation cancelling phase when the function button 60 of the wireless station STA is depressed. In the illustrated example of FIG. 10, it is assumed that the user depresses the function button 60 of the wireless station STA after completion of the reservation phase shown in FIG. 7. In other words, it is assumed that the user depresses the function button 60 of the wireless station STA, while the LED 172 of the access point AP1, the LED 372 of the access point AP3 and the LED 72 of the wireless station STA are all on.

When the user depresses the function button 60 of the wireless station STA (step S602), the wireless station STA cancels the own reservation (step S603), turns off the own LED 72 (step S604) and broadcasts a probe request including reservation cancelling request in its vendor-specific information element (step S606).

The access point AP1 that has received the probe request including reservation cancelling request cancels the own reservation (step S608) and turns off the LED 172 (step S610). The access point AP1 then sends back a probe response including the own group ID (group ID: A) in its vendor-specific information element to the wireless station STA (step S612). Similarly, the access point AP3 that has received the probe request including reservation cancelling request cancels the own reservation (step S614) and turns off the LED 372 (step S616). The access point AP3 then sends back a probe response including the own group ID (group ID: A) in its vendor-specific information element to the wireless station STA (step S618). When receiving the probe request including reservation cancelling request, the access point AP2 that has not yet performed the reserving operation sends back a probe response including the own group ID (group ID: B) in its vendor-specific information element to the wireless station STA (step S620).

When a preset time period (for example, 10 seconds) has elapsed since broadcasting the probe request including reservation cancelling request, the process at the wireless station STA returns to the object candidate specifying phase to change over to a next object candidate of sharing operation. More specifically, the wireless station STA specifies an access point having the second highest RSSI value as a next object candidate of sharing operation.

Even when the reservation cancelling request has not reached the access point due to, for example, packet dropping, the access point cancels the reservation after elapse of a preset time period (for example, 120 seconds).

When the access point receives a new reservation request from the reserved wireless station and the group ID included in the new reservation request is different from the own group ID, the access point cancels the reservation. This handles the possibility that the reserving operation has been performed with the wrong group ID. When the access point receives a reservation cancelling request from another wireless station different from the reserved wireless station, on the other hand, the access point does not cancel the reservation. This prevents the reservation from being forcibly cancelled by any unexpected wireless station.

A3. Effects of Embodiment

In the wireless LAN system 1000 of the embodiment, when the user depresses the function button 60 of the wireless station STA, the access point AP1 having the RSSI value that is not less than the preset level and is the highest, the access point AP3 having the same group ID as that of the access point AP1, and the wireless station STA respectively turn on their LED 172, LED 372 and LED 72. The user is thus readily informed of which access point is specified as the object candidate of sharing operation by simply checking whether the LED is on or off. Additionally, since the reserving operation is performed between the wireless station and the access point before the sharing operation and turns on the LED of the reserved device, this prevents the setting information from being shared or exchanged between the user's unexpected devices.

Since the LEDs of both the access point AP1 and the access point AP3 are turned on, the user can select and depress the WPS button of the device easier to the user. For example, the user may select and depress the WPS button of a communication device located closest to the user. In this embodiment, since the access point AP1 and the access point AP3 have the identical group ID, the wireless station can obtain the same setting information, irrespective of the user's selection of the WPS button.

The user is only required to depress the WPS button illuminated by the LED and can thus readily understand the operation procedure. The LED emits light in the WPS button, so that the user can readily locate the WPS button to be depressed even when the wireless station or the access point is provided in dark environment.

As described above, the embodiment improves the user's convenience in sharing the setting information between communication devices.

### B. Modifications

The disclosure is not limited to the above embodiment, but various modifications including the modifications described below may be made to the embodiment without departing from the scope of the disclosure; some of possible examples are given below.

Modification 1:

Although the wireless station STA specifies the two access points AP1 and AP3 having the same group ID as the object candidates of sharing operation in the above embodiment, the wireless station STA may specify only the access point AP1 as the object candidate of sharing operation. In the latter case, the series of processing based on the group ID may be omitted. Another suitable identifier, e.g., BSSID (Basic Service Set Identifier), may be used as the identifier of the access point, instead of the group ID.

Modification 2:

According to the above embodiment, the automatic setting process for sharing the setting information is triggered by the user's depression of the function button 60 of the wireless station STA. According to one modification, the wireless station STA may be configured to broadcast a probe request in the object candidate specifying phase on each power supply when sharing the setting information has not yet been completed, for example, immediately after product shipment or at the time of resetting the hardware. This automatically starts the process for sharing the setting information. In this Modification, it is desired to set a significantly large value (for example, about 90% of the maximum value) to threshold of the RSSI value used in the object candidate specifying phase. Setting a significantly large value to the threshold of the RSSI value prevents the sharing operation of the setting information with a communication device possessed by, for example, a next-door third person.

Modification 3:

Although the wireless station STA and the access points AP1, AP2 and AP3 include the LED as the means for indicating completion of the reserving operation in the above embodiment, each of these communication devices may include, for example, a display to visually notify completion of the reserving operation or a speaker to notify completion of the reserving operation with sound, instead of or in addition to the LED.

Although the LED is provided in the WPS button in the above embodiment, the LED may be provided at a different location from the WPS button. The LED may be replaced by another light source, such as an organic light-emitting diode or a light bulb.

Modification 4:

Although the wireless station STA and the access points AP1, AP2 and AP3 include the WPS button as the means for receiving the user's instruction for performing the sharing operation, each of these communication devices may include a touch panel or functionality for receiving the user's instruction via a WEB browser, instead of or in addition to the WPS button.

Modification 5:

The network configuration of the wireless LAN system 1000 described in the above embodiment is only illustrative, and the wireless LAN system 1000 may include plural wireless stations STA or plural access points AP. The access point AP1 or the wireless station STA may have plural wired LAN ports or may not have any wired LAN port. Additionally, the access point AP1 may be connected to an external network via a router or may be connected with plural wireless stations. The wireless LAN system 1000 is required to include a communication device having at least access point function and a communication device having at least station function.

Modification 6:

Although the Ethernet converter is illustrated as the wireless station STA in the above embodiment, the wireless station STA is not restricted to this implementation but may be any communication device having station function. The communication device may be, for example, PDA (Personal Digital Assistant). Additionally, the access point AP or the wireless station STA may be mounted on any of various electronic devices. Alternatively, the access point AP or the wireless station STA may be a wireless communication adapter connected to any of various home electric appliances to provide the home electric appliance with wireless communication function.

Modification 7:

Although WPS is used as the protocol for implementing the sharing operation in the above embodiment, the protocol is not specifically limited but may be, for example, AOSS. The protocol used for implementing the sharing operation is not limited to the protocol performed between the access point and the station unsymmetrically. More specifically, a protocol performed between wireless communication devices specified to have unsymmetrical positions, such as master-slave relationship, may be used as the protocol for implementing the sharing operation. Alternatively, a protocol performed between two stations may be used as the protocol for implementing the sharing operation.

Modification 8:

Although the access point sends a probe response including the own group ID in the above embodiment, the access point may send beacon including the own group ID. This modification enables the automatic setting process to be performed even when the wireless station STA uses passive scan.

Modification 9:

Part of the functions implemented by the software configuration in the above embodiment may be implemented by the hardware configuration, whilst part of the functions implemented by the hardware configuration in the above embodiment may be implemented by the software configuration.

Modification 10:

In the above embodiment, the object candidate specifying phase starts when the function button 60 of the wireless station STA is depressed. Alternatively, the object candidate specifying phase may start when the WPS button 70 is depressed. In the latter case, depressing the WPS button 70 again after the object candidate specifying phase and the reservation phase starts the sharing operation phase. Thus, the WPS button 70 of the wireless station STA may be operated twice in the automatic setting process described above. When the WPS button 70 has the functionality of the function button 60, the function button 60 may be omitted. Alternatively, the function button 60 may have the functionality of the WPS button 70.

Modification 11:

In the above embodiment, before the start of the sharing operation phase by the first sharing operation module 13 of the wireless station STA and the second sharing operation module of the access point, the first specification module 11 of the wireless station STA and the second specification module of the access point activate the object candidate specifying phase, and subsequently the first reserving operation module 12 of the wireless station STA and the second reserving operation module 112 of the access point activate the reservation phase. The object candidate specifying phase and the reservation phase of the embodiment are, however, not essential. For example, the first sharing operation module 13 of the wireless station STA and the second sharing operation module of the access point may use the respective LEDs to preliminarily notify the status ready for the sharing operation (key exchange) between these devices, prior to actual key exchange in the WPS or AOSS-based sharing operation. When the respective WPS buttons are depressed after such preliminary notification, the first sharing operation module 13 of the wireless station STA and the second sharing operation module of the access point may cooperatively perform actual sharing operation (key exchange). Accordingly, the first specification module 11 and the first reserving operation module 12 of the wireless station STA and the second specification module and the second reserving operation module of the access point may be omitted.

The foregoing has described an illustrative embodiment. The disclosure is, however, not restricted to the embodiment or the configuration described above. The disclosure includes various modifications and equivalents. Additionally, although various elements of the disclosure are described in diverse combinations and structures, these are only illustrative, and the number of each element may be increased, decreased or even one. Any of such modifications should also be embraced in the scope of claims.

What is claimed is:

1. A wireless local area network (LAN) system comprising:
a first communication device; and
a second communication device, the first and second communication devices performing a sharing operation of sharing setting information for establishing a wireless LAN connection, wherein
the first communication device comprises
a first notification module that notifies a ready status for the sharing operation between the first communication device and the second communication device prior to performing the sharing operation; and
a first instruction receiving module that receives an instruction for performing the sharing operation in cooperation with the second communication device after the notifying by the first notification module, and
the second communication device comprises
a second notification module that notifies a ready status for the sharing operation between the first communication device and the second communication device prior to performing the sharing operation; and
a second instruction receiving module that receives an instruction for performing the sharing operation in cooperation with the first communication device after the notifying by the second notification module.

2. The wireless LAN system of claim 1, wherein the first communication device further comprises:
a first specification module that specifies the second communication device as an object candidate of the sharing operation;
a first reserving operation module that performs a first reserving operation to allow for the sharing operation between the first communication device and the second communication device specified as the object candidate; and
a first sharing operation module that performs a first sharing operation by sharing first setting information with the second communication device.

3. The wireless LAN system of claim 2, wherein
the first notification module performs the notifying when the first reserving operation is completed.

4. The wireless LAN system of claim 3, wherein
the first instruction receiving module receives an instruction for performing the first sharing operation when the first reserving operation is completed.

5. The wireless LAN system of claim 4, wherein
the first sharing operation module performs the first sharing operation when the instruction for performing the first sharing operation is received by the first instruction receiving module.

6. The wireless LAN system of claim 5, wherein the second communication device further comprises:
a second specification module that specifies the first communication device as an object of the sharing operation;
a second reserving operation module that performs a second reserving operation to allow for the sharing operation between the second communication device and the specified first communication device; and
a second sharing operation module that performs a second sharing operation by sharing second setting information with the first communication device.

7. The wireless LAN system of claim 6, wherein
the second notification module performs the notifying when the second reserving operation is completed.

8. The wireless LAN system of claim 7, wherein
the second instruction receiving module receives an instruction for performing the second sharing operation when the second reserving operation is completed.

9. The wireless LAN system of claim 8, wherein
the second sharing operation module performs the second sharing operation when the instruction for performing the second sharing operation is received by the second instruction receiving module.

10. The wireless LAN system of claim 2, wherein
the first specification module specifies, as another object candidate of the sharing operation, a third communication device having setting information identical to setting information of the second communication device specified as the object candidate.

11. The wireless LAN system of claim 10, wherein
the first sharing operation module performs the first sharing operation with one of the second and third communication devices having the instruction for performing the sharing operation received first.

12. The wireless LAN system of claim 2, wherein the first communication device further comprises:
a third instruction receiving module that receives an instruction for activating the first specification module to start specifying the object candidate of the sharing operation.

13. The wireless LAN system of claim 2, wherein
the first specification module starts specifying the object candidate of the sharing operation when the setting information is not shared.

14. The wireless LAN system of claim 2, wherein
the first specification module specifies the object candidate of the sharing operation based on a strength of a radio signal sent from a plurality of communication devices including the second communication device.

15. The wireless LAN system of claim 1, wherein
each of the first instruction receiving module and the second instruction receiving module include a light source and perform the notification by emitting light from the light source.

16. The wireless LAN system of claim 15, wherein
each of the first instruction receiving module and the second instruction receiving module include a button, and
the light source is disposed inside the button and the button is configured to allow light emitted from the light source visible on an exterior of the button.

17. The wireless LAN system of claim 15, wherein
the light source is a light emitting diode (LED).

18. A communication device in a wireless local area network (LAN) that performs a sharing operation of sharing setting with another communication device to establish a connection with the another communication device, the communication device comprising:
a notification module that notifies a ready status for the sharing operation between the communication device and the another communication device prior to performing the sharing operation; and
an instruction receiving module that receives an instruction for performing the sharing operation in cooperation with the another communication device after the notifying by the notification module.

19. A communication device in a wireless local area network (LAN) that performs a sharing operation of sharing setting information with another communication device to establish a connection with the another communication device, the communication device comprising:
a notification module that notifies a ready status for the sharing operation between the communication device and the another communication device prior to performing the sharing operation;
an instruction receiving module that receives an instruction for performing the sharing operation in cooperation with the another communication device after the notifying by the notification module;
a specification module that specifies the another communication device as an object candidate of the sharing operation;
a reserving operation module that performs a reserving operation to allow for the sharing operation between the communication device and the another communication device specified as the object candidate; and
a sharing operation module that performs a sharing operation by sharing setting information with the second communication device, wherein
the notification module performs the notifying when the reserving operation is completed,
the instruction receiving module receives an instruction for performing the sharing operation when the reserving operation is completed, and
the sharing operation module performs the sharing operation when the instruction for performing the sharing operation is received by the instruction receiving module.

20. A communication device in a wireless local area network (LAN) that performs a sharing operation of sharing setting information with another communication device to establish a connection with the another communication device, the communication device comprising:
a notification module that notifies a ready status for the sharing operation between the another communication device and the communication device prior to performing the sharing operation;
an instruction receiving module that receives an instruction for performing the sharing operation in cooperation with the another communication device after the notifying by the notification module;
a specification module that specifies the another communication device as an object of the sharing operation;
a reserving operation module that performs a reserving operation to allow for the sharing operation between the communication device and the specified another communication device; and
a sharing operation module that performs a sharing operation by sharing setting information of the communication device with the another communication device, wherein
the notification module performs the notifying when the reserving operation is completed,
the instruction receiving module receives an instruction for performing the sharing operation when the reserving operation is completed, and
the sharing operation module performs the sharing operation when the instruction for performing the sharing operation is received by the instruction receiving module.

21. A method of performing a sharing operation of sharing setting information for establishing a wireless LAN connection between a first communication device and a second communication device, the method comprising:
first notifying, by the first communication device, a ready status for the sharing operation between the first communication device and the second communication device prior to performing the sharing operation;
second notifying, by the second communication device, a ready status for the sharing operation between the first communication device and the second communication device prior to performing the sharing operation;
first receiving, at the first communication device, an instruction for performing the sharing operation in cooperation with the second communication device after the first notifying; and
second receiving, at the second communication device, an instruction for performing the sharing operation in cooperation with the first communication device after the second notifying.
